(19) United States
(12) Patent Application Publication
(10) Pub. No.: US 2015/0237807 A1
(43) Pub. Date: Aug. 27, 2015

(54) Continuous bioprocess for organic greenhouse agriculture

(71) Applicant: Marc-Andre Valiquette, Saint-Hyacinthe (CA)

(72) Inventor: Marc-Andre Valiquette, Saint-Hyacinthe (CA)

(73) Assignee: Bioponix Technologies Inc., Saint-Lambert (CA)

(21) Appl. No.: 14/544,862

(22) Filed: Feb. 26, 2015

Related U.S. Application Data
(60) Provisional application No. 61/944,660, filed on Feb. 26, 2014.

(51) Int. Cl. A01G 1/00; A01G 9/02

(52) U.S. Cl. CPC A01G 1/001; A01G 9/02

(57) ABSTRACT

A method of plant cultivation which comprises inoculating plants in a plant growing system comprising a container and an insert therefore, the microbial inoculant containing at least one species from the following group of microorganisms comprising arbuscular mycorrhizae associated bacteria, plant growth promoting rhizobacteria, yeast microorganisms and substrate conditioning bacteria.

### FIELD OF THE INVENTION

The present invention relates to compositions and methods for biofertilization, biostimulation and bioprotection of cultivated plants.

More particularly, the present invention comprises compositions and methods for effectively improving off-ground plant production and reducing the environmental consequences of salt based fertilizer and chemical pesticide use. Additionally, the compositions and methods of this invention can be used to sustainably manage soil, water and fertilizer use. Additionally, the compositions and methods of this invention can be used to reconstitute soil and mycorhizosphere environments that cultivated plants normally encounter while living in their natural in-ground habitat, as well as promoting vigorous plant growth and development, and to sustainably encourage natural plant resistance to stress, insects and disease.

The present invention also relates to bioremediation, for the creation of modular grey water treatment system infrastructures, using especially chosen cultivated marsh plants in a specific high performance, low maintenance phytopurification bioprocess system and method.

The present invention also relates to agriculture, and more particularly, relates to a high performing horizontal and vertical off-ground greenhouse integrated plant growing system and method.

### BACKGROUND OF THE INVENTION

Bioprocess is a biotechnology that uses large concentrations of micro-organisms for the purpose of mass production of commercial bioproducts. For instance, the use of bacterial strains of Rhodococcus rhodochorus for the production of protease inhibitor precursors for use in the biopharmaceutical industry, the use of the budding yeast Saccharomyces cerevisiae for the production of beer in the beverage industry, the use of bacterial strains of Xanthomonas campestris for the production of xanthan gum on a commercial scale for use in the food industry, or the use of bacterial strains of Microbacterium laevaniformans for the production of levan on a commercial scale for use in the cosmetics industry, as well as strains of the yeast Kluyveromyces lactis for the production of chymosin (rennet) on a commercial scale for the dairy industry.

Bioprocess technology can be used during either short periods of time for short production cycles (discontinuous bioprocess) or long periods of time (continuous bioprocess) for long production cycles, all depending on the ability of the microorganisms to secrete the desired product, or any other desired result. It is always carried in a special fostering environment in which those microorganisms will indeed find all of the ideal conditions for their optimal growth, development and desired biological activity. The term bioreactor designates such environments.

Large concentrations of microorganisms can also be used in agriculture. Many investigators in the area of soil ecology have discovered a considerable amount of microorganisms to be present in the volume of soil occupied by plant roots, more precisely the thin layer of soil (about 1 to 2 mm thick) surrounding the roots. These microorganisms are thought to have no direct consequence on plant growth and vigour. The shear extent of crop roots in soil suggests that a significant portion of soil is actually within the influence of the root zone (about 5 to 40% of soil in the rooting zone depending upon crop root architecture). This area has been termed as being the rhizosphere. It has been discovered that a few microbial species present in the rhizosphere are either deleterious or beneficial to plant growth. The bacterial species that are beneficial to plant growth and development have been termed Plant Growth Promoting Rhizobacteria, or PGPR.

As well, other soil ecology investigators have discovered that some distinct species of soil molds and yeasts also have plant growth promoting traits. They have been termed Plant Growth Promoting Fungi, or PGPF. Their morphology and mode of action are substantially different from those of yet another group of beneficial fungi called arbuscular mycorrhizae, that have also been proven to be beneficial for plant development.

Taken together, all of those microbial consortia create a very rich and complex ecosystem, or biome, around plant roots. The term mycorhizosphere stands for the volume of soil directly in contact with both roots and fungal filaments, and that is directly influenced by them.

The term mycorhizoplane designates the surface of fungal filaments and their associated plant roots, on which distinct beneficial bacterial populations called PGPR can adhere to create a thin sheath formation called a biofilm. A biofilm is created by a bacterial cell migration process called quorum sensing. The term rhizocompetence designates the ability of some bacterial species to adhere to both mycelial filaments and nourishing plant root hairs. It has been found that the tripartite symbiosis between bacteria, fungi and the nourishing plant roots constitutes the fundamental explanation of soil fertility. The science of PGPR is thus relatively young in comparison to the knowledge and use of nitrogen fixing bacteria. For the moment, its applications to crop production are limited but the science is developing rapidly. Growers and the crop production industry are well adviced to keep ahead of its newest developments. Many producers have exploited to great success the use of inoculants containing nitrogen fixing bacteria to limit the need for costly fertilizers in legume crops. As we aim to optimize the performance of all crops, the value of inoculating soil with other microorganisms, or promoting the activity of endogenous residing beneficial microorganisms through sustainable management practices, are being considered worldwide.

As used herein, the acronym PGPR stands for Plant Growth Promoting Rhizobacteria. The acronym PGPF stands for Plant Growth Promoting Fungi. Of those microbial crop growth promoters, PGPR are the most abundant in soil. They can in turn be classified into many groups according to their function in both the rhizosphere and the rhizoplane:

MHB stands for Mycorhization Helper Bacteria

MAB stands for Mycorhizae Associated Bacteria

NFB stands for Nitrogen Fixing Bacteria

PSB stands for Phosphate Solubilizing Bacteria

PDB stands for Polysaccharide Decomposing Bacteria

PHPB stands for Plant Hormone Stimulating Bacteria

PSHB stands for Plant Stress Homeoregulating Bacteria. These include beneficial rhizosphere bacteria with probiotic activity

SCB stands for Substrate Conditioning Bacteria

The term geoponic agriculture stands for traditional full soil (also called in-ground) agriculture. The word off-ground stands for plant culture that is performed outside of a full soil environment. It does indeed apply to container gardening. Plant culture can also be done using soil-less media. Current technologies for off-ground, soil-less plant production include the followings:

### A. Partial Immersion Culture Systems: Hydroponics Systems.

1. NFT Nutrient Film Technique: Nutrients are directly brought to each individual plant by a thin film of running water. This technique fosters excellent plant development when appropriate salt-based fertilizers and pH stabilizers are provided. However, this method has considerable risks, as the roots are not protected against insect pests and devastating oomycete pathogens such a Phytophthora or Pythium.

2. Aeroponics: In this method, the plant roots are kept moist by a continuous mist of nutrient water sprayed on them in a closed environment. Water droplets then unite together to form heavier drops on the roots, and flows down by gravity, hence wetting the entire root mass hanging in the saturated moist air. This high maintenance, very expensive but high performance system offers nonetheless little protection against aerial pathogens and thermic shock plant stress brought by temperature variations.

3. Ultraponics (or airoponics) It is an improved aeroponic plant culture system in which ultrasonic mist generation systems are used to bring water and appropriately dissolved salt-based fertilizers directly on root surfaces. The ultra-fine mist allows the elaboration of a more abundant root system. This very sophisticated system requires considerable initial installation investment and highly trained technical personnel.

4. Hydroponics is a general term that encompasses many off-ground culture techniques using water as a carrier for nutritive elements, and generally uses salt based nutrient solutions to feed the plant roots that are located in a soilless substratum, such as either glass wool, stone wool, perlite, pumice stone, vermiculite, coco choir, clay beads or kenaf palm fibers. Unfortunately, this system is not ecological since water and its dissolved salt based nutrients can only be used once for keeping a wet substrate and wet roots. As well, hydroponic growers who use imputrescible rooting substrates such as rockwool or glasswool cannot rely on composting for recycling their rooting substrates, hence generating a considerable amount of inorganic waste.

5. High tide-low tide systems. This technique uses low but wide plastic containers called tide tables, that are filled with standard hydroponic soilless rooting medium. The substrate is kept wet by the addition of water and nutrients that are left stagnant for a certain period of time. Then, water is drained and is replaced by air. This allows roots to be oxygenated in between high tides. Then, the cycle is repeated over and over. Very wasteful in water, this system is not adapted to all plants, allows the spread of vascular diseases and requires a tight control of pH and electrical conductivity.

6. Dripping systems. This system uses a soilless rooting substrate contained in medium size buckets with pierced bottoms, as well as drippers, irrigation pipes and water pumps. At least one dripper is dedicated for the hydration of its associated plant specimen. For more efficiency, two drippers might be used per plant. Water containing appropriately dissolved salt-based fertilizers wets the contents of the plant container and streams down to leave the pot through holes located at the bottom. It is the classical small scale homegrown hydroponic system for beginners. In this system, water can be reused reused, but attention should be given to pH imbalance and uncontrolled algal or microbial over proliferation.

7. Continuous flow systems. In this system, plants grow in pierced containers that are filled with clay beads. There is also a system of water pumps and air pumps associated to the planting containers. Water containing diluted salt-based fertilizers is allowed to drip continuously on top of the beads and stream down to the bottom by gravity. The continuous flow of nutrient water through a closed loop system allows roots to get plenty of water and oxygen. This system requires air pumps as well as water pumps, and does not allow water economy. Its limitations are constant monitoring of pH and microbial over proliferation and the possibility to foster plant pathogens and root diseases.

It is important to notice that in all cases of hydroponic culture, water and the mineral salts it contains have to be discarded once plants have been harvested, which contributes to water and fertilizer waste.

### B. Complete Immersion Culture Systems: Aquaculture Systems.

This technology requires that the entire root system of the plants should be immersed in still standing water, while an air pump injects air in the water. The bubbling prevents root hypoxia while agitating the water. It requires a constant watch on salinity and pH and uses al large amount of salt based nutrients. It cannot protect the plants against vascular fungal diseases.

The term geoponic agriculture stands for traditional full soil (also called in-ground) agriculture. The word off-ground stands for plant culture that is performed outside of a full soil environment, and does apply to container gardening. The well-known limit of geoponic agriculture using containers is brought by the spiral root formation that usually happens in non-copper coated traditional containers. Prior art teaches, of a container for plants in which there is proven nourishing root differentiation in an upper layer of organic compost phase, located in the superior part of the recipient. This plant container is described in U.S. Pat. No. 6, 247,269 and U.S. Pat. No. 7,036,273 and shares common inventorship with the present invention, the teachings thereof being incorporated by reference. In this type of specialized container, the tap root system is allowed to differentiate in the lower part of the recipient, into the water reservoir. Sandwiched in between those two regions, a buffer zone of air and moist non-soil medium such as vermiculite will naturally allow the creation of these two rhizosphere zones. The presence of numerous apertures at the level of the rootforming interface zone indeed allows the complete development of root tissues, and decreases considerably, if not completely, the spiral root formation that usually happens in non-copper coated traditional pot cultures. In doing so, the procedure of repotting is eliminated.

However, to date, there has been no attempt to create a comprehensive and integrated off-ground plant growing system that actually uses soil or compost as a natural, organic controlled microbial substratum being part of a bioreactor technology that would not lead to root congestion. The bioprocess it fosters could effectively bring selected microbial populations together in a dynamic consortium expressly using organic, non salt-based fertilizers, for the purpose of sustainable, high performance organic greenhouse food production. The worldwide market for organic agriculture products is considerable, as the needs for wholesome food production without the use of salt based fertilizers and chemical pesticides keep increasing, and gain more and more consideration for a well aware public. As well, studies have clearly proven the health and environmental dangers of mass production and animal consumption and open field testing of genetically modified organisms (GMO). Public awareness concerning these dangers have prompted the search for more sustainable agriculture methods. As well, the concept of food sovereignty is one of the major trends for the future. It stands for the fundamental right of a State to freely choose its own agricultural crops and policies, without interfering or damaging the environment, and without any negative consequences on its neighbors, while keeping food product imports from other regions of the world at a minimum.

As well, to date, there has been no attempt to create a low cost, comprehensive and integrated off-ground system that actually uses soil or compost as a natural, organic controlled microbial substratum being part of a bioreactor technology that will effectively bring selected microbial populations together in a dynamic consortium expressly using organic and inorganic wastes for the purpose of water depollution. This water depollution system can expressly use organic waste instead of non salt-based plant fertilizers, and selected water filtering marsh plants growing in a modular, artificial marsh like infrastructure environment for effective water phytopurification and treatment. On a worldwide scale, the needs for treatment of water waste are considerable, indeed, inexpensive and effective water waste treatment is the first concern in public health.

### SUMMARY OF THE INVENTION

It is an object of the present invention to provide a plant cultivation system wherein plant growth is enhanced by the use of a controlled and selected microbial consortium that is expressly beneficial for plant development and resistance to disease.

It is an object of the present invention to provide a plant cultivation system wherein plant growth is enhanced by the use of a controlled and selected microbial consortium and controlled concentrations and compositions of organic plant fertilizers that are beneficial for plant development and resistance to disease.

It is an object of the present invention to provide compositions and methods useful in the techniques of off-ground organic greenhouse agriculture.

It is an object of the present invention to provide compositions and methods useful in the creation and maintenance of healthy and clean soil environments for off-ground agriculture.

It is an object of the present invention to provide compositions and methods useful in improving the qualities of soil.

It is an object of the present invention to provide compositions and methods useful in controlling odors generated by organic fertilizers standing still in a water reserve.

It is a further object of the present invention to provide a plant cultivation method wherein soil remineralization is allowed for continuous plant growth.

It is a further object of the present invention to provide a plant cultivation method wherein microbial replenishing is allowed for permanent conditioning of soil and water environments for maintenance of perfect plant health.

The bioprocess at work in the present invention can be enhanced by the addition of microorganisms that are involved in probiotics for effective control of plant pathogens and root diseases. They include antibiotics, microorganisms that secrete siderophores for antibiosis against pathogens, endophytes for prevention of spreading infections, microorganisms that are involved in the ISR and SAR.

According to one aspect of the present invention, the bioprocess at work in the present invention should happen in a plurality of steps, in an orderly fashion both in time and in space to ensure robust plant health, and the choice of micro-organisms should be done accordingly.

The designated microbial species described herein should be viewed as suggested examples.

The first step of the bioprocess is mycorrhizal inoculation (Glomus irregulare, Glomus mossae, Glomus etunicatum, Glomus fasciculatum spp)

The second step of the bioprocess is providing proactive opportunistic rhizosphere colonization by distinct species of Mycorrhizae Associated Bacteria. They are fungus-specific but not plant-specific. (Bacillus pumilus, Bacillus subtilis)

The third step of the bioprocess is the recruitment of some distinct rhizocompetent PGPR bacterial species (Pseudomonas fluorescens, Pseudomonas aeruginosa, Pseudomonas putida, Paenibacillus polymyxa, Azospirillum brasilense, Enterobacter agglomerans, Bacillus megatherium, Azotobacter chroococcum, Arthrobacter globiformis) and bacterial endophytes (Burkholderia cepacia) and fungal endophytes (Piriformospora indica)

The fourth step of the bioprocess is appropriate biofilm nutrition by some distinct PGPF species such as (Saccharomyces cerevisiae, Pichia pastoris, Yarrowia lipolytica)

A fifth step of the bioprocess is compost phase conditioning by distinct SCB species, especially lactic bacteria such as (Lactobacillus casei, Bacillus coagulans, Lactobacillus acidophilus, Lactobacillus plantarum, Streptomyces lactis)

A sixth step of the bioprocess can be controlled organic matter decomposition by distinct PDB species (Rhodobacter capsulatus) and fungi (Trichoderma harzianum).

The word bioponic comes from the old Greek words bios, for life, and ponos, for work. It is a very different plant culture approach than hydroponics, in which the work is performed through the actions and properties of water. In the case of bioponic agriculture, the myriads of life forms found in the system indeed contribute considerably to the work effort for plant growing. It also applies to the area of water purification, where the combined actions of plants and selected microorganisms contribute together in the effort of bioremediation of water waste.

It is an object of the present invention to avoid water and fertilizer waste. Bioponic agriculture allows the use of all of the water, microbial conditioners and organic fertilizer inputs. It is important to notice that in all cases of hydroponic culture, water and the mineral salts it contains have to be discarted once plants have been harvested, which contributes to water and fertilizer waste.

### DETAILED DESCRIPTION OF THE INVENTION

The present invention comprises compositions and methods for bioprotection, biostimulation, biofertilization, and maintenance of healthy soil ecosystems for off-ground organic greenhouse agriculture.

The off-ground plant culture recipient used in organic greenhouse agriculture has to be conceived in order to prevent the spiral root formation that usually happens in non-copper coated traditional containers for plants. The prior art teaches a container for plants in which there is proven nourishing root differentiation in an upper layer of organic compost phase, located in the superior part of the recipient, and a so-called radication interface to prevent root congestion and overcrowding. This plant container is described in U.S. Pat. No. 6, 247,269 and U.S. Pat. No. 7,036,273 and shares common inventorship with the present invention.

As far as microbial compositions are concerned, they may comprise a mixture of microorganisms, comprising arbuscular mycorrhizae, bacteria, fungi, algae, protozoa, bacterial endophytes, fungal endophytes, and/or indigenous or exogenous microorganisms, all of which form a distinct and functioning micro-ecosystem with distinct roles for its various members.

Composition and methods of the present invention may act individually or synergistically in order to promote plant growth. The synergic action happens as part of a structured bioprocess in both space and time, and not at random. For example, in a composition of the present invention, one group of microorganisms may enhance the contact surface area between the plant roots and the soil substratum, a second group of microorganisms can establish itself on the root system as a preemptive, opportunistic colonizer in order to constitute a protective biofilm covering the root surface, the preemptive colonizers subsequently encouraging the recruiting and permanent establishment of a third group of microbes that will promote more root and shoot growth, hence more establishment of more beneficial microorganisms through recruitment or quorum sensing in a circadian cycle mechanism, a fourth group of microorganisms can participate in the feeding and the biostimulation of the plant roots and their associated microbial consortia, while a fifth group of microorganisms can regulate the physico-chemical parameters of the soil environment. Another group of microorganisms with an extensive metabolic repertoire may decompose organic molecules and oxidize toxic degradation products, while still a further group will may effectively promote optimal soil ecology by keeping natural soil defenses against undesirable microbial invaders such as plant pathogens or root diseases. As well, micro-organisms may consume specific substances in the soil environment and produce metabolic compounds that act as nutrients for other microorganisms, thus creation a sustainable biome for keeping perfect health of both microbial and plant life over a long term period in the plant culture system.

Compositions of the present invention may provide microorganisms that produce bioactive compounds or biological agents including, but not limited to phytohormones, cytokines, antibiotics or siderophores.

Compositions of the present invention comprise at least one micro-organism that belong to specific microbial groups: Arbuscular mycorrhizae; early opportunistic preemptive root colonizers such as Mycorrhizae Associated Bacteria (MAB) and Mycorrhization Helper Bacteria (MHB); selectively recruited beneficial plant growth promoters, such as Plant Growth Promoting Rhizobacteria (PGPR) and bacterial and fungal plant endophytes; selected PGPF such as intraspecific variants of yeasts for proper biofilm stimulation and nourishment; lactic bacterial populations for constant soil conditioning, such as Aerobic Endospore Forming Bacteria (AEFB) or Substrate Conditioning Bacteria (SCB); and active decomposers of complex organic matter, such as Polysaccharide Decomposing Bacteria (PDB) or lignicolous fungi.

According to one aspect of the present invention, the bioprocess at work in the present invention should happen in a plurality of steps, progressing in an orderly manner both in time and in space, and the choice of micro-organisms should be done accordingly. The designated microbial species should be viewed as suggested examples.

The first step of the bioprocess is mycorrhizal inoculation by arbuscular mycorrhizae such as (Glomus irregulare, Glomus mossae, Glomus etunicatum, Glomus fasciculatum spp). The present invention includes compositions that include at least one species of mycorrhizae. They provide nutrition, secrete enzymes and provide a very elaborated filamentous network in the soil called a mycelium, increase the contact surface between soil and plant root tissues, and increase the ability of the various bacterial species to colonize the rhizosphere. The mycorrhizal mycelium attracts specific types of bacteria, called Mycorrhization Helper Bacteria, and Mycorhizae Associated Bacteria that complete the symbiosis association and cooperate together for the proper nutrition and mutualistic symbiosis between the plant and the fungus.

Mycorrhizal fungi are known universal symbionts living in close association with the majority of terrestrial plants. Ectomycorrhizal fungi are strictly aerobic, and are associated to most evergreen and deciduous trees. Ericoid mycorrhizae are associated with Ericaceae plants that live in acidic soil environments, such as cranberries and blueberries. Arbuscular mycorrhizae are associated with herbaceous plants as well as numerous deciduous shrubs and fruit trees, which make up more than 80% of the flora and include most of the cultivated crops. Mycorrhizae are obligate symbionts and cannot survive without living in close association with plants. They are the microorganism of first choice for initiating the steps of a continuous bioprocess in a perfectly aerobic, nonfermentative bioreactor system designed to improve plant yields. The network of filaments they create in soil provide the necessary attachment support for mycorhizocompetent beneficial bacterial populations. Mycorhizae can improve plant yields by a better supply of mineral nutrients, increase the production of flowers, protect the roots against phytopathogens, reduce transplantation shock due to an improved water supply, increase resistance to drought, promote early vegetable growth, induce a better firmness in plant tissues, which contribute to extend the period of cold storage, increase the survival rate to winter frosts and contribute to stabilize soil particles. With their extensive filament network, mycorrhizal fungi dramatically increase the area of root absorption in the soil much more than that of feeder roots and hairs. As well, mycorrhizae are strict aerobes that live very well in a thin soil layer of high porosity compost such as the one that characterize the bioreactor design herewithin.

The second step of the bioprocess is preemptive rhizosphere colonization by distinct species of Mycorrhizae Associated Bacteria. The present invention comprises compositions that include at least one species of Mycorrhizae Associated Bacteria and at least one species of Mycorrhization Helper Bacteria. They are known to be fungus-specific but not plant-specific. (Bacillus pumilus, Bacillus subtilis, Pseudomonas fluorescens, Pseudomonas putida) They actively colonize the rhizoplane and include mycorhizocompetent bacterial strains that provide preemptive opportunistic colonization. Preemptive colonization helps to prevent infection of newly formed root tissue by undesireable microorganisms or pathogens because MAB have the advantage of being at the root site first. They also form bacterial biofilms on the surface of the roots for further protection. MAB and MHB colonize the rhizoplane using plant root exudates as nutrients. This colonization has a probiotic action in that it can spatially exclude potential pathogenic bacteria and fungi. They also can solubilise phosphorous, stimulate root growth, secrete growth metabolites, chelate minerals for better uptake and also secrete natural mucilage in the form of a biofilm that improves soil structure through aggregate formation.

The third step of the bioprocess is complementary PGPR recruitment of distinct species of PGPR microorganisms by early opportunistic colonizers that already occupy and protect the root site. The present invention preferably comprises compositions that include at least one species of PGPR and one species of bacterial endophyte and preferably at least one species of fungal endophyte. Early colonizers can be either rhizoplane bacteria (Pseudomonas fluorescens, Pseudomonas aeruginosa, Pseudomonas putida, Paenibacillus polymyxa, Azospirillum brasilense, Enterobacter agglomerans,) and bacterial endophytes (Pseudomonas, Bacillus, Enterobacter, Agrobacterium, Burkholderia) and fungal endophytes (Piriformospora indica).

Endophytes are non-pathogenic microorganisms that are adapted for specifically living inside of plant tissues such as plant roots and shoots without doing harm and gaining benefit other than securing residency. Some are internal colonists with apparently neutral behavior, others are symbionts. The latter are known to actively reduce stresses and assist plant growth, health and defense. In general, endophytic bacteria originate from epiphytic bacterial communities of the rhizosphere and phyllophane, as well as endophyte-infected seeds, soil substrate or other planting materials.

They enter plant tissues either through wounds due to insect or nematode damage, through natural openings in root hairs, at the base of lateral roots, or by secreting powerful lytic enzymes such as cellulase and pectinase to locally damage the root cuticle at the point of entry. The capacity of these helpful bacteria and fungi to colonize internal plant tissues could confer a selective or an ecological advantage over those that stay on the root or plant surface, because the internal tissues of plants provide a more protective and uniform living environment. It has been shown that PGPR and endophyte recruitment starts at the level of the rhizoplane, because of the proven continuum of root-associated microorganisms from the rhizosphere to the rhizoplane to the root epidermis to the cortex and the shoot itself. An effective inoculum preferably contains endophyte microbial species and strains with high rhizocompetence.

Plant Growth Promoting Rhizobacteria (PGPR) can act in many different ways, and can be classified into many groups according to their function in the rhizosphere and rhizoplane:

MHB stands for Mycorhization Helper Bacteria

MAB stands for Mycorhizae Associated Bacteria

NFB stands for Nitrogen Fixing Bacteria

PHPB stands for Plant Hormone Stimulating Bacteria

PSB stands for Phosphate Solubilizing Bacteria

PSHB stands for Plant Stress Homeoregulating Bacteria. These include beneficial rhizosphere bacteria with probiotic activity.

To be considered as a PGPR, a bacterial species has to fulfill 2 out of these 3 conditions:

1. Active colonization of the rhizoplane

2. Proven plant growth stimulation

3. Phytopathogen biocontrol abilities

PGPR that have a biofertilizer activity are available for increasing crop nutrient uptake of nitrogen from nitrogen fixing bacteria associated with roots (Azospirillium), iron uptake from siderophore producing bacteria (Pseudomonas), sulfur uptake from sulfur-oxidizing bacteria (Thiobacillus), and phosphorus uptake from phosphate-mineral solubilizing bacteria (Bacillus, Pseudomonas).

Some PGPR species also have a biostimulant activity. For instance, species of Pseudomonas and Bacillus can produce phytohormones or growth regulators that cause crops to have greater amounts of fine roots which have the effect of increasing the absorptive surface of plant roots for uptake of water and nutrients and higher mycorrhization density. These PGPR are referred to as biostimulants and the phytohormones they produce include indole-acetic acid, indole-butyric acid, cytokinins, gibberellins, nitrous oxide and inhibitors of ethylene production.

The fourth step of the bioprocess is sustainable biofilm nutrition by distinct, selected beneficial microorganisms, especially PGPF yeasts. The present invention comprises compositions that include at least one species of PGPF. (Saccharomyces cerevisiae, Pichia pastoris, Aureobasidium pullulans, Yarrowia lipolytica, Metchnikowia fructicola, Cryptococcus albidus). Microorganisms that are specialized for doing this live freely in the rhizosphere, and unlike biofilm-dwelling PGPR bacteria, they do not require the presence of a physical support for growing and proliferating. They contain considerable starch reserves, and upon presence of soil microorganisms, interact positively with them and allow the progressive release of glucose through the gradual breakdown of their starch reserves. They also interact favorably with certain bacterial species living freely in the compost phase, conferring them a selective advantage. They also can supply plants with growth factors and stimulants. The latter stimulates a molecular response in plant cells which facilitates the synthesis of natural phytohormones that are responsible for excellent plant growth. Yeasts with PGPF activity also play a role in the bioprotection of cultures against phytopathogens, in that they effectively compete against undesireable fungi for nutrition, bacterial companionship and space. As well, one should not forget about the proven plant growth promoting effects and probiotic effects of a considerable number of organic compounds contained in yeast extracts. Those are released upon the mortality of yeast cells in the soil.

The fifth step of the bioprocess is compost phase conditioning by distinct species of SCB, including either lactic bacteria (Lactobacillus casei, Lactobacillus acidophilus, Streptococcus lactis, Streptococcus agalactiae, Leuconostoc fallax) or members of the Firmicutes (Bacillus coagulans, Bacillus racemilacticus). The present invention comprises compositions that include at least one species of soil conditioning bacteria. This step happens in the rhizosphere, and the soil environment is conditioned with minute amounts of lactic acid conferring a permanent, slightly acidic pH that creates a premium microbial environment that selects in favor of beneficial PGPR and PDB microbial species. The bioprotection against pathogenic invaders is thus guaranteed, and some bacterial species can also play a role in bioremediation by scavenging and metabolizing toxic metabolic putrefaction by-products such as hydrogen sulfide, carbon dioxide, methane gas and ammonia. They also can be considered as SCB species as well.

A possible sixth step of the bioprocess is controlled organic matter decomposition by distinct species of both bacterial decomposers that are part of the PDB group (Streptomyces spp, Rhodobacter capsulatus), and fungal decomposers (Trichoderma harzianum). The present invention comprises compositions that include at least one bacterial species of active decomposers and at least one fungal species of active decomposers. Their role is to assist the work of endogenous decomposers that are already present in soil or compost, such as Actinomyces spp and methanogens, in a pH zone that is maintained stable by the actions of selected SCB species. This step happens at the level of the rhizosphere, and its purpose is to allow the various elements found in the soil ecosystem to dissociate themselves from their organic molecular constituents and complete their respective natural cycle into their transformation as plant nutrients, a process called nutrient biogeochemical cycling. These microbial agents can be classified in the PDB group. The present invention also comprises compositions that may include a special group of PDB called purple bacteria (Rhodobacter sphaericus, Rhodobacter capsulatus). They are excellent soil conditioners and decomposers, because of their extensive metabolic repertoire and their ability to metabolize large amounts of sulphur containing contaminants, ammonia and methane gas that might be generated through the process of putrefaction. Uncontrolled putrefaction of organic fertilizers may lead to root morbidity and mortality because of their toxicity, and selected bacterial species can prevent overaccumulation of toxic degradation by-products.

The present invention can include compositions that may also include at least one distinct species of probiotic microorganisms for the purpose of protection of low resistance crops to various plant pathogens. Bacteria of the PSHB group that are active in slightly acidic soil environments maintained as such by lactic acid bacteria can be added as an additional step for probiotic and bioprotection purposes. Bioprotection inoculants deliver biological control agents of plant disease. Those are organisms capable of slowing the growth or even eradicating other organisms that might be pathogenic or causing disease to crops. Bacteria in the genera Bacillus, Streptomyces, Pseudomonas, Burkholderia, Plantaoe and Agrobacterium are the biological control agents of first choice. They suppress plant disease through at least one of these 3 mechanisms: induction of systemic resistance, production of siderophores or production of antibiotics.

Exposure to the PGPR triggers a defense response by the crop as if attacked by pathogenic organisms. The crop is thus armed and prepared to mount a successful defense against eventual challenge by a pathogenic organism.

Production of siderophores by some PGPR can scavenge heavy metal micronutrients in the rhizsophere (e.g. iron) thus starving pathogenic organisms from complete nutrition that could allow them to mount an attack against crops. Plants seem nonetheless able to still acquire adequate micro-nutrient supply in the presence of these PGPR.

Antibiotic producing PGPR release compounds that prevent the growth of pathogens or competitors.

The French word terroir designates a given rural region that is characterized according to its ancestral or traditional agricultural or agri-food productions. Terroir biodesign engineering is an area of biotechnology in which specific strains of soil micro-organisms can be put together to expressly and intently recreate traditional natural habitat cultivated soil environments for proper crop biostimulation and biofertilization.

In one aspect of the invention, all of those microbial populations can be added gradually in time, in order to act in specific locations in the soil ecosystem and achieve the purpose of either mycorhizosphere bioengineering or terroir biodesign. The microbial populations should be replenished on a regular basis such as weekly, in order to reach a large, effective biomass, as the specific needs of the plants should increase. The constant replenishing of the microfloral populations through microirrigation at the surface of the soil substratum will allow permanent selection of the most rhizocompetent microbial strains. This is especially useful when specific bacterial populations have to be maintained in permanence for the re-creation of natural soil microbial populations that plants encounter in their natural habitat. For instance, the natural soil habitat of tomatoes is especially rich in various Burkholderia species that can be maintained permanently in the greenhouse soil ecosystem through regular replenishings.

The term biofertilization refers to the ability of certain microbial populations to actively feed the nourishing roots of plants. Such populations include symbiotic nitrogen fixing bacteria (NFB) such as Rhizobium, and non-symbiotic nitrogen fixing bacteria such as Azospirillum brasilense or Azotobacter. They also include phosphorus-solubilizing micro-organisms (PSB), such a fungal phosphate solubilizers like vesicular arbuscular mycorrhizae, soil moulds like Aspergillus, or enterobacteria like Serratia marcescens.

The term biostimulation refers to a group of bacteria that are known to synthesize plant hormones such as auxins, gibberellic acids and cytokines that play an important role in plant development. As well, some bacterial populations also interfere with the biosynthesis of ethylene, which stimulates flowering but inhibits root formation. Nitrous oxide (NO) is also a plant hormone whose amounts can be regulated by beneficial bacteria. Those bacteria are grouped under the denomination PHSB, for Plant Hormone Stimulating Bacteria.

The term bioprotection refers to a group of microorganisms that stimulate the natural plant defense mechanisms when in presence of fungal or bacterial invaders. They include members of the group of PSHB (Plant Stress Homeoregulating Bacteria). As well, a few fungal and bacterial species have a nematicide action. Bacteria that condition the soil by the secretion of antibiotics, hydrogen peroxide, lactic acid or larvicides can also be used as bioprotectants. The secretion of lactic acid inhibits the growth of harmful bacteria.

The compositions of the present invention comprise a combination of microorganisms that have proven biofertilization, biostimulation and bioprotection properties. Taken together, they have a positive influence on plant growth and agricultural yields.

The plant culture system of the present invention should include all of the necessary infrastructures for automatically providing water, light, fertilizers and microbial inocula at any desired time. It includes the presence of timers, solenoid valves, proportional fertilizer injectors, water pumps, water tanks, filters, check valves, dripping irrigation lines and strong, steel supporting stand structures for appropriate stability of the trough-like receivers, in the case of vertical agriculture installations. The use of supporting structures and stands that are made of wood has to be avoided, because of the natural alveolar structure of wood itself, in which aerial spores of fungal plant disease and minuscule insect pest eggs and larvae might take cover in between greenhouse infestations. An important aspect of the invention resides in the fact that water should be in permanent unidirectional movement in the bottom of the though-like receivers, so that the lower half of the inferior part of the cassette inserts should be submerged at all times. This will encourage root growth through the slotted inserts, and capillary uptake and movement of water molecules through contact with the hydrophilic clay beads or cork bark chunks, for optimal soil moisture conservation, fostering optimal microbial welfare and overall optimal plant development. Hence, it will encourage the continuous probiotic bioprocess in the aerobic bioreactor assembly, which is based on the action of microorganisms that naturally require their high porosity soil environment to be kept moist at all times. This in turn will further encourage root and shoot growth. The fact that the water is kept running at all times will also allow optimal water oxygenation and optimal microbial probiotic action against fungal diseases that might thrive in stagnant water such as Phytophthora. It is indeed of primordial importance to provide a system in which water is kept running at all times in a bioponic agriculture situation. In a preferred embodiment of the invention, water can be recirculated in a closed loop system configuration thanks to the action of a pump. The pump should allow water movement as follows: it should be drawn from a large tank and pumped up to the other end of the system in order to reach each individual trough, for circulation in the bottom of each trough, before falling in the collection tank, where the cycle can be repeated, thus keeping the water in a constant movement and a constant state of oxygenation. In parallel with the ever recirculating water at the bottom of the system for permanent hydration of the tap root system of plants, an entirely robotized watering system can be provided for providing automatic and reliable fertilizer and bacterial conditioners to each individual plant specimen. This should be done through dripping irrigation on the top part of the individual cassette inserts, directly on the compost phase at the base of the plants, for providing fertilizers and microorganisms to the superficial (nourishing) root system conveniently found in the proximity of said dripping irrigation device.

The term bioremediation refers to a group of microorganisms that can remove pollutants frequently encountered in sewage water or industrial effluents. Those bacteria are grouped together as SCB and PDB.

It is also an object of the present invention to provide a water filtration and treatment system in which selected marsh plants are grown with a continuous supply of bacterial inoculum, and a continuous supply of grey or brown water. These marsh plants can include tall species such as Typha and Phragmite, and dwarf filtration plants such as Deschampsia. The three plants should be grown together in the same artificial marsh environment with the basic principle of growing only one plant species per cassette insert. This will promote biodiversity and avoid the mistakes of monoculture.

It is also an object of the present invention to provide a biological, light weight modular water purification system in which selected filtration marsh plants and selected microbial water conditioners are grown together with a continuous supply of grey or brown water for phytopurification purposes, and function along a bioprocess that is inspired from nature.

This water purification system is also an example of bioponics. As mentioned earlier, the marsh plants of first choice for performing the filtration work are Deschampsia, Phragmites and Typha. Those perennial plants are known to have a very extensive root system. Hence, they require a deeper bioreactor cassette insert element that will contain a larger volume of soil. Instead of containing a thin layer of soil, the bioreactor environment has to be at least twice as large, that is, the cassette element has to be deeper. Just like in the case when the same technological system is used for agriculture, grey or brown water as well as microbial inoculants have to be brought to the surface of the bioreactor by dripping irrigation.

The elaborated root system of marsh plants and their mycorrhizal symbionts will effectively perform effective filtration work and retain colloid particulate material contained in waste water. These particles will effectively be trapped and made available for the decomposing work done by SCB and PDB bacterial species that are replenished weekly in the system. The bacterial inoculum will also bring MHB on a regular basis to further assist root growth, root mycorhization and improve the water filtration process. The bacterial inoculum will also bring SCB for providing a controlled environment for biome stability. Other distinct bacterial species brought by the bacterial inoculum are PDB that will effectively decompose the colloidal organic particles contained in waste water, and other bacterial populations will make the decomposition products available for absorption by mycorrhizae. The latter will bring the final decomposition products, ie plant nutrients, directly to the roots of the plants. Other distinct bacterial populations such as PGPR species will encourage robust plant growth for effective water treatment.

Hence, this system allows grey and brown water to be used as natural, organic fertilizer solutions. As an example, colloidal particles containing protein and lipid organic constituents will be decomposed by effective decomposers like bacteria of the PDB group, and nitrogen will be released as ammonia. Bacteria of the NFB and SCB groups will transform ammonia and nitrogen into nitrate, that will then be absorbed by mycorrhizae. Sulphur contained in amino acids such as cystine will be processed by purple bacteria for transformation into sulphates that will also be absorbed as a plant nutrient by mycorrhizae.

The inoculum can also be biodesigned in order to meet the different characteristics of the waste water to be treated more effectively. In one aspect of the invention, for instance, if the water should contain anormally high amounts of industrial pollutants, the inoculum can be biodesigned to contain higher concentrations of bacteria with an extensive metabolic repertoire such as purple bacteria like Rhodobacter sphaeroides. In another aspect of the invention, if water contains an excessively large concentration of sulphur or nitrates, the inoculum can be biodesigned in order to contain larger concentrations of sulphur bacteria such as Thiobacillus denitrificans. In another aspect of the invention, water containing large amounts of radioisotopes can be treated with an inoculum containing strains of bacteria that can sequester radioactive isotopes such as Micrococcus radiodurans.

The present invention brings an integrated solution to most problems encountered in traditional organic greenhouse plant culture. These problems include the following:

Traditional organic greenhouse agriculture does not systematically allow the control of microbial biota.

The thin layer of high porosity organic compost located in the superior part of the specialized recipient for bioponic agriculture is indeed a premium environment for encouraging the proliferation of beneficial micro-organisms for plant development. These micro-organisms are very well known to us: they include arbuscular mycorhizae as well as their naturally associated microbial consortia. As a matter of fact, this highly aerobic environment is indeed a very rich biome, in which beneficial plant-microbe interactions are enhanced as part of a very specific process, instead of at random. Hence, this aptly named continuous bioprocess will encourage the gradual constitution of an important root, fungal and bacterial biomass. This indeed constitutes the main functions of a bioreactor. Its applications and benefits are considerable. Many research reports confirm the use of microbial consortia for improved yields with many different types of cultures of economic significance.

Traditional organic greenhouse agriculture does not systematically allow a probiotic approach to plant growth.

Probiotics is a strategy designed to keep and maintain natural soil defenses against plant pathogens and telluric diseases. Plants will show increased resistance against bacterial and cryptogamic diseases. Those pathogens are very well known, and they are traditionally propagated through contaminated soil and draughts.

Traditional organic greenhouse agriculture does not systematically allow intrinsic pest control.

The choice and selection of beneficial micro-organisms used in this new type of agriculture will also allow better plant nourishment, and will eliminate the use of chemical pesticides. It will in fact considerably facilitate pest control through the natural induction of permanent plantborne defense mechanisms such as Induced Systemic Resistance, and Systemic Acquired Resistance. As well, it will eliminate the use of salt based mineral fertilizer, it will allow optimal management of organic plant fertilizers and will completely eliminate any waste of water.

Traditional organic greenhouse agriculture methods that are commonly practiced in full soil include a great amount of hard physical work.

In bioponic agriculture, keeping a productive organic greenhouse is not a matter of sweat or manhours, it is a question of technology and robotics.

Traditional organic greenhouse agriculture requires weekly addition of fresh compost:

The overly tedious procedure of weekly adding fresh organic compost at the base of the plants is also eliminated in bioponic agriculture. Soil remineralization and microbial replenishment can be done through the regular addition of organic soil amendments and microbial inocula, respectively. Those 100% natural products are esaily available under very concentrated and homogenous solution preparations, and are easily delivered directly and automatically at the base of each plant, through the use of traditional greenhouse equipment such as proportional injectors and microirrigation drippers.

Traditional organic greenhouse agriculture may require irrigation by aspersion.

Mineral and microbial replenishment are performed through microirrigation, directly at the base of each plant. This technology eliminates the use of aspersion irrigation devices, which have been proven to contribute to disease propagation. Splashing on contaminated soil that is not covered with a thin polytene film contributes to the dissemination of spores and diseases both in the greenhouse and in the field, especially when environmental conditions are excessively warm and humid.

Traditional organic greenhouse agriculture work brings risks of disease infestations.

As mentioned earlier, the weekly addition of fresh compost at the base of the plants is eliminated when growers rightly choose bioponic agriculture to replace traditional in-ground approach to plant growth. The addition of fresh compost is a tedious chore done with cumbersome equipment that disturbs plants. The constant coming-and-going of greenhouse laborers with wheelbarrows and shovels is usually accompanied by plant damage and injuries of all kinds to the leaves and stems. This in turn leads to the apparition and spreading of diseases, usually soilborne and airborne cryptogamic diseases. Bioponic agriculture and probiotic mycorhizosphere bioengineering will only need the direct, necessary interventions for light plant trimming and fruit harvesting, thus reducing the occurrence of diseases to the plants.

Traditional organic greenhouse agriculture requires grafting and difficult techniques. Probiotic agriculture under bioponic management considerably simplifies the usual protection procedures against hard-to-eliminate telluric diseases such as corky root disease of tomatoes. Control of this disease includes grafting a resistant root cultivar on a productive head. Grafting is a technique that is not always well mastered by most organic growers, and conies with considerable loss of young plants and supplemental costs for the producer. Under bioponic culture conditions, plants thrive by using their own natural roots, and the grower can choose on whether or not his root masses will feed either one or multiple heads per plant specimen.

Traditional organic greenhouse agriculture does not systematically prevent roots from heat shock.

Keeping plants in specialized containers brings the advantage of keeping a warm root mass as well, compared to in-ground culture. Hence, organic culture can be extended throughout the year, especially if the greenhouse installation can be used during the winter. This opens new and exciting possibilities in organic agriculture: the use of warm floors, solar heaters, and even geothermal heat for a more energy-efficient, state-of-the-art and high-performance year-round organic greenhouse installation. It is the ideal solution for growers who have to cope with temperature variations in temperate and nordic areas of the world.

Traditional organic greenhouse agriculture requires rotations of cultures.

Our off-ground plant production technology eliminates the obligation to perform culture rotation. In traditional organic greenhouse production, the same soil is often used for growing the same plant species year after year. This will expose the plant roots to pathogens that may stay dormant for long periods of time in soil, such as microsclerotiae, conidiae, pycnids, half decomposed yet viable infected plant parts, etc. This system will simply bring the grower to use the same amount of compost only once, thus completely eliminating the risk of root diseases.

Traditional organic greenhouse agriculture requires a long acclimation and certification period.

Probiotic culture under bioponic management offers the possibility to use a key-in-hand, all-in-one growing system and method that is easy to understand and 100% organic.

Traditional organic greenhouse agriculture is strictly horizontal. Another considerable advantage brought to the grower by probiotic culture under bioponic management is the possibility to grow plants vertically, on a multilevel system. This increases the productivity per square foot of greenhouse surface, compared to traditional purely horizontal cultures at ground level or on long tables or hydroponic NFT channels.

Traditional organic greenhouse agriculture is universal.

Probiotic culture under bioponic management is compatible to a wide variety of vegetables, ornamental and shrub plants. The only plants that would be grown with difficulty would be large specialized root plants such as carrots and potatoes.

Traditional organic greenhouse agriculture is wasteful in water and fertilizers.

Bioponic greenhouse agriculture allows optimal use of water and plant fertilizers, and is very cost-effective as per manpower time. Water and nutrients are recuperated and recirculated, just as well as what happens in the case of pump-and-dump hydroponics systems. Evapotranspiration of water through the leaves is in fact the only way for water to escape our system. This system design allows plants to be well nourished as well as well stimulated, always naturally healthy and disease resistant.

Traditional organic greenhouse agriculture brings root competition.

Our innovative plant culture concept is designed for optimizing plant growth, and the culture of only one individual specimen is recommended for each recipient. Hence, any intraspecific or interspecific competition is eliminated. It is nevertheless possible to have a choice of many different plant species along a single row, as long as roots won't meet and compete. Being individually contained in their own distinct recipient will bring plants specimens to fully develop without wasting photosynthetic energy into fighting against each other for root space. The grower can nevertheless appreciate the trophic effects of mixing herbs with small plants that might be susceptible to pests, thus naturally protecting them. This is the basic principle of plant companionship.

Traditional organic greenhouse agriculture has limited bioprotection strategies. This bioponic system uses water that can be conditioned with the addition of beneficial, protective microorganisms that might act as plant protectants. For instance, bacteria of the genus Streptomyces can be used as an inoculum to protect the fragile roots against destructive oomycete contaminations such as Phytophthora or Pythium. Hydroponic growers are always on the look-out for these pests, and their damages can be considerable. In bioponics, prevention is much better . . . and cost efficient than the cure!

As well, beneficial micro-organisms are much more than plant growth promoters. Some species also have an insecticide, larvicide and nematicide action. This is another example of the bioprotective actions of those microbes. Those populations just have to be regularly replenished in order to allow the compost phase to act as a probiotic war zone against invaders.

Traditional organic greenhouse agriculture soil supplements can be used in bioponic agriculture.

It is noteworthy to recall that probiotic agriculture under bioponic management is absolutely compatible with many of the natural soil amendments that can be found on the market place. For instance, natural soil additives such as bat guano, bone meal fertilizer, dried blood powder preparations, seaweed extracts, granular hen manure compositions, marine composts and especially vermicompost (earthworm excreta) can indeed enhance the performance of bacterial inocula, and it is up to the grower to prepare his most appropriate formulation for use in our growing system. We strongly encourage this type of experimentation and the sharing of the information.

Traditional organic greenhouse agriculture does not systematically allow rhizosphere microbial population control for natural yield increases.

A bioponic system for plant growing is indeed a continuous bioprocess that recreates full soil conditions that are the most appropriate for any given plant. Its natural soil conditions can be recreated easily with inocula that mimic their natural root habitat. This is the beauty of mycorhizosphere bioengineering. It has nothing to do with genetically modified organisms or bioengineered agri-foods. Indeed, it is a beneficial microbial activity concentrator. The creation of abundant microbial biota will naturally encourage strong root and shoot growth. Bioponics clearly outperforms the other systems when growing certain plant species types. Many growers noted increased root health and specimen vitality, larger stem thickness and more vibrant leaf colors. Unsurprisingly, there is greater resistance to soilborne disease as well. This system has been developed for medium to large greenhouses, and can be used in comparison to other devices in the same space. Add to this the ease of system pruning and grooming that is so desirable by growers when growing vine crops, multiple harvest edible flowers and leafy brasing greens would allow for longer harvest duration and greater revenue potential for certain produce or fruit.

Traditional organic greenhouse agriculture may require soil fumigation. The traditional way to “cure” the soil of an organic greenhouse from soilborne phytopathogens is to use fumigants. Current fumigants are being either banned, or restricted in use, or are too costly for annual crop producers. The use of bioprotectants in an off-ground culture system is a valuable alternative to fumigation. Biofertilizers and biostimulants are now considered as being a valuable means to reduce fertilizer costs, improve timing of nutrient availability and crop uptake to prevent contamination of water and air with nutrients. The organic crop production industry requires new means to protect crops and supply nutrients. Probiotic mycorhizosphere bioengineering is the newest way to solve the constraints brought by organic greenhouse food production.

Traditional organic greenhouse agriculture does not systematically optimize inoculum potency.

Bacterial inocula used in bioponic agriculture have a proven reach that goes far beyond the advantages that are traditionally brought to the plant by complete and abundant nutrition. Indeed, they keep the soil substratum as a living and thriving environment, instead of as an inert one. They have the proven actions:

1. Bioconditioning of soil substrate to keep pH stable and prevent uncontrolled putrefaction

2. Biofertilization, especially nitrogen fixation and phosphate solubilization

3. Remineralization of soil substrate through organic fertilizer processing

4. Phytoprotection, through stimulating plant defense mechanisms

5. Biostimulation of plant growth and development

6. Mycorhization assistance of the rhizosphere.

Bioponic agriculture systematically allows the control of compost phase biota. The thin layer of high porosity organic compost located in the superior part of the specialized recipient for bioponic agriculture is indeed a premium environment for encouraging the proliferation of beneficial micro-organisms for plant development. These micro-organisms are very well known to us: they include arbuscular mycorhizae as well as their naturally associated microbial consortia. As a matter of fact, this highly aerobic environment is indeed a very rich biome, in which beneficial plant-microbe interactions are enhanced as part of a very specific process, instead of at random. Hence, this aptly named continuous bioprocess will encourage the gradual constitution of an important root, fungal and bacterial biomass. This indeed constitutes the main functions of a bioreactor. Its applications and benefits are considerable. Many research reports confirm the use of microbial consortia for improved yields with many different types of cultures of economic significance (Gamalero et al 2002, Berta 2005).

Bioponic agriculture systematically allows the use of probiotic strategies. Probiotics is a strategy designed to keep and maintain natural soil defenses against plant pathogens and telluric diseases. Plants will show increased resistance against bacterial and cryptogamic diseases. Those pathogens are very well known, and they are traditionally propagated through contaminated soil and draughts.

Bioponic agriculture systematically avoids water and fertilizer waste, and the use of pesticides.

The choice and selection of those beneficial micro-organisms used in this new type of agriculture will also allow better plant nourishment, and will eliminate the use of chemical pesticides. It will in fact considerably facilitate pest control through the natural induction of permanent plantborne defense mechanisms such as Induced Systemic Resistance, and Systemic Acquired Resistance. As well, it will eliminate the use of salt based mineral fertilizer, it will allow perfect management of organic plant fertilizers and will eliminate waste of water.

Bioponic agriculture eliminates tedious chores associated to plant culture.

The overly tedious procedure of weekly adding fresh organic compost at the base of the plants is also eliminated in bioponic agriculture. Soil remineralization and microbial replenishment can be done through the regular addition of organic soil amendments and microbial inocula, respectively. Those 100% natural products are esaily available under very concentrated and homogenous solution preparations, and are easily delivered directly and automatically at the base of each plant, through the use of traditional greenhouse equipment such as proportional injectors and microirrigation drippers.

Bioponic agriculture avoids the use of aspersion irrigation devices and water waste.

Mineral and microbial replenishment are performed through microirrigation, directly at the base of each plant. This technology eliminates the use of aspersion irrigation devices, which have been proven to contribute to disease propagation. Splashing on contaminated soil that is not covered with a thin polytene film contributes to the dissemination of spores and diseases both in the greenhouse and in the field, especially when environmental conditions are excessively warm and humid.

Bioponic agriculture systematically prevents mechanical plant damage.

As mentioned earlier, the weekly addition of fresh compost at the base of the plants is eliminated when growers rightly choose bioponic agriculture to replace traditional in-ground approach to plant growth. The addition of fresh compost is a tedious chore done with cumbersome equipment that disturbs plants. The constant coming-and-going of greenhouse laborers with wheelbarrows and shovels is usually accompanied by plant damage and injuries of all kinds to the leaves and stems. This in turn leads to the apparition and spreading of diseases, usually soilborne and airborne cryptogamic diseases. Bioponic agriculture and probiotic mycorhizosphere bioengineering will only need the direct, necessary interventions for light plant trimming and fruit harvesting, thus reducing the occurrence of diseases to the plants.

Bioponic agriculture systematically eliminates the need of grafting disease sensitive plants.

Probiotic agriculture under bioponic management considerably simplifies the usual protection procedures against hard-to-eliminate telluric diseases such as corky root disease of tomatoes. Control of this disease includes grafting a resistant root cultivar on a productive head. Grafting is a technique that is not always well mastered by most organic growers, and comes with considerable loss of young plants and supplemental costs for the producer. Under bioponic culture conditions, plants thrive by using their own natural roots, and the grower can choose on whether or not his root masses will feed either one or multiple heads per plant specimen.

Bioponic agriculture systematically prevents heat shock to the roots.

Keeping plants in specialized containers brings the advantage of keeping a warm root mass as well, compared to in-ground culture. Hence, organic culture can be extended throughout the year, especially if the greenhouse installation can be used during the winter. This opens new and exciting possibilities in organic agriculture: the use of warm floors, solar heaters, and even geothermal heat for a more energy-efficient, state-of-the-art and high-performance year-round organic greenhouse installation. It is the ideal solution for growers who have to cope with temperature variations in temperate and nordic areas of the world.

Bioponic agriculture systematically prevents the need of rotation of cultures.

Our off-ground plant production technology eliminates the obligation to perform culture rotation. In traditional organic greenhouse production, the same soil is often used for growing the same plant species year after year. This will expose the plant roots to pathogens that may stay dormant for long periods of time in soil, such as microsclerotiae, conidiae, pycnids, half decomposed yet viable infected plant parts, etc. Our system will simply bring the grower to use the same amount of compost only once, thus completely eliminating the risk of root diseases.

Bioponic agriculture is easy to implement.

Probiotic culture under bioponic management offers the possibility to use a key-in-hand, all-in-one growing system and method that is easy to understand and 100% organic, and that will finance itself completely as early as before the end of the first year of production.

Bioponic agriculture is a high yield system.

Our bioponic approach to plant growth has proven itself to be a high performance, low maintenance system. It also offers the grower the possibility to fully automatize his plant culture installation.

Bioponic agriculture systematically allows vertical farming.

Another considerable advantage brought to the grower by probiotic culture under bioponic management is the possibility to grow plants vertically, on a multilevel system. This increases the productivity per square foot of greenhouse surface, compared to traditional purely horizontal cultures at ground level or on long tables or hydroponic NFT channels.

Bioponic agriculture is suitable to most plants species.

Probiotic culture under bioponic management is compatible to a wide variety of vegetables, ornamental and shrub plants. The only plants that would be grown with difficulty would be large specialized root plants such as carrots and potatoes.

Bioponic agriculture is cost effective.

This type of greenhouse agriculture allows optimal use of water and plant fertilizers, and is very cost-effective as per manpower time. Water and nutrients are recuperated and recirculated, just as well as what happens in the case of pump-and-dump hydroponics systems. Evapotranspiration of water through the leaves is in fact the only way for water to escape our system. This system design allows plants to be well nourished as well as well stimulated, always naturally healthy and disease resistant.

Bioponic agriculture allows plant companionship.

Our innovative plant culture concept is designed for optimizing plant growth, and the culture of only one individual specimen is recommended for each recipient. Hence, any intraspecific or interspecific competition is eliminated. It is nevertheless possible to have a choice of many different plant species along a single row, as long as roots won't meet and compete. Being individually contained in their own distinct recipient will bring plants specimens to fully develop without wasting photosynthetic energy into fighting against each other for root space. The grower can nevertheless appreciate the trophic effects of mixing herbs with small plants that might be susceptible to pests, thus naturally protecting them. This is the basic principle of plant companionship.

Bioponic agriculture systematically allows efficient bioprotection of cultures.

Our bioponic system uses water that can be conditioned with the addition of beneficial, protective microorganisms that might act as plant protectants. For instance, bacteria of the genus Streptomyces can be used as an inoculum to protect the fragile roots against destructive oomycete contaminations such as Phytophthora or Pythium. Hydroponic growers are always on the look-out for these pests, and their damages can be considerable. In bioponics, prevention so much better . . . and cost efficient than the cure!

Bioponic agriculture systematically prevents soil pest infestations.

Beneficial micro-organisms are much more than plant growth promoters. Some species also have an insecticide, larvicide and nematicide action. This is another example of the bioprotective actions of those microbes. Those populations just have to be regularly replenished in order to allow the compost phase to act as a probiotic war zone against invaders.

Bioponic agriculture is compatible to traditional organic soil amendments.

It is noteworthy to recall that probiotic agriculture under bioponic management is absolutely compatible with many of the natural soil amendments that can be found on the market place. For instance, natural soil additives such as bat guano, bone meal fertilizer, dried blood powder preparations, seaweed extracts, granular hen manure compositions, marine composts and especially vermicompost (earthworm excreta) can indeed enhance the performance of bacterial inocula, and it is up to the grower to prepare his most appropriate formulation for use in our growing system. We strongly encourage this type of experimentation and the sharing of the information.

Bioponic agriculture allows rhizosphere bioengineering.

A bioponic system for plant growing is indeed a continuous bioprocess that recreates full soil conditions that are the most appropriate for any given plant. Its natural soil conditions can be recreated easily with inocula that mimic their natural root habitat. This is the beauty of mycorhizosphere bioengineering. It has nothing to do with genetically modified organisms or bioengineered agri-foods. Indeed, it is a beneficial microbial activity concentrator. The creation of abundant microbial biota will naturally encourage strong root and shoot growth. Bioponics clearly outperforms the other systems when growing certain plant species types. Many growers noted increased root health and specimen vitality, larger stem thickness and more vibrant leaf colors. Unsurprisingly, there is greater resistance to soilborne disease as well. This system has been developed for medium to large greenhouses, and can be used in comparison to other devices in the same space. Add to this the ease of system pruning and grooming that is so desirable by growers when growing vine crops, multiple harvest edible flowers and leafy brasing greens would allow for longer harvest duration and greater revenue potential for certain produce or fruit.

Bioponic agriculture systematically avoids the use of fumigants.

The traditional way to “cure” the soil of an organic greenhouse from soilborne phytopathogens is to use fumigants. Current fumigants are being either banned, or restricted in use, or are too costly for annual crop producers. The use of bioprotectants in an off-ground culture system is a valuable alternative to fumigation. Biofertilizers and biostimulants are now considered as being a valuable means to reduce fertilizer costs, improve timing of nutrient availability and crop uptake to prevent contamination of water and air with nutrients. The organic crop production industry requires new means to protect crops and supply nutrients. Probiotic mycorhizosphere bioengineering is the newest way to solve the constraints brought by organic greenhouse food production.

Bioponic agriculture systematically allows the full benefits of soil conditioning.

Bacterial inocula used in bioponic agriculture have a proven reach that goes far beyond the advantages that are traditionally brought to the plant by complete and abundant nutrition. Indeed, they keep the soil substratum as a living and thriving environment, instead of as an inert one. They have the proven actions:

1. Bioconditioning of soil substrate to keep pH stable and prevent uncontrolled putrefaction

2. Biofertilization, especially nitrogen fixation and phosphate solubilization

3. Remineralization of soil substrate through organic fertilizer processing

4. Phytoprotection, through stimulating plant defense mechanisms

5. Biostimulation of plant growth and development

6. Mycorhization assistance of the rhizosphere.

### BRIEF DESCRIPTION OF THE DRAWINGS

FIG. 1 shows a perspective view of trough-like receiver and cassette insert;

FIG. 2 shows a longitudinal section of cassette insert inside trough-like receiver;

FIG. 3 shows the same lateral view of both shallow and deep cassette inserts;

FIG. 4 shows two lateral views of shallow cassette insert;

FIG. 5 shows two lateral views of deep cassette insert;

FIG. 6 shows the step of mycorhizal inoculation in bioreactor environment;

FIG. 7 shows the step of Mycorhizal germination in bioreactor environment;

FIG. 8 shows the step of mutual Mycorhizal and root growth in bioreactor environment;

FIG. 9 shows the step of Mycorhizal infection of root tissues in bioreactor environment;

FIG. 10 shows the step of Mycorhizal colonization of root with MHA and MHB preemptive colonizer species in bioreactor environment;

FIG. 11 shows the step of PGPR and bacterial endophyte and fungal endophyte recruitment by MHA and MHB preemptive colonizers in bioreactor environment;

FIG. 12 shows the step of PGPF nourishing action on colonized roots and on SCB lactic acid producing bacterial populations in bioreactor environment;

FIG. 13 shows the step of SCB soil conditioning, especially lactic acid-producing bacterial populations in bioreactor environment;

FIG. 14 shows the step of controlled PDB action in bioreactor environment; and

FIG. 15 shows the step of PSHB probiotic action in bioreactor environment.

### DESCRIPTION OF THE PREFERRED EMBODIMENTS

The aim to allow spatial segregation and functional differentiation of the two main root populations according to their respective nutrient and water absorbing functions has been met by the creation and development of the original culture recipient and method described in U.S. Pat. No. 6,247,26 that shares common inventorship with the present invention.

Hence, the nourishing roots will be properly differentiated in a thin layer of high porosity organic compost phase, located in the superior part of the recipient. The tap roots will be differentiated and located in the lower part of the recipient, into the water reservoir. Sandwiched in between those two regions, a buffer zone of air and moist non-soil medium will naturally allow the creation of these two rhizosphere zones.

The presence of numerous apertures at the level of the rootforming interface zone indeed allows the complete development of root tissues, and decreases considerably, if not completely, the spiral root formation that usually happens in non-copper coated traditional pot cultures. In doing so, the procedure of repotting is eliminated.

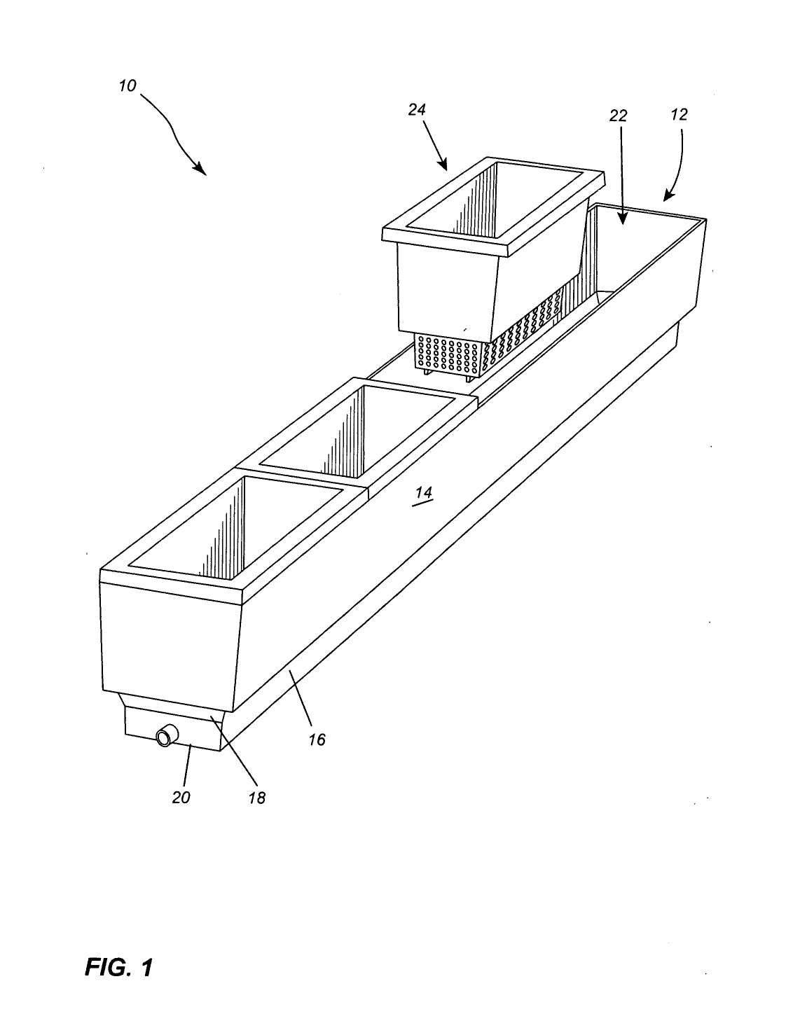

Turning to the arrangement shown in FIG. 1, there is illustrated a plant growth system 10 which is similar to that shown in prior art U.S. Pat. No. 6,247,269 and U.S. Pat. No. 7,038,273 which shares common inventorship with the present invention and which are incorporated herein by reference. Accordingly, only a portion of the container system is illustrated herein.

As shown in FIG. 1 there is provided a plant growth system 10 which includes an outer container generally designed by reference numeral 12. The outer container 12 has an upper side wall 14 and a lower side wall 16 which are joined together by merging section 18. There is also provided a bottom wall 20. The said container has a considerably elongated form, to create a trough like recipient 22. There is also provided at least one inner insert 24 of the type illustrated in U.S. Pat. No. 6,247,269, with a few modifications, as will be described herein. The inserts are placed along a straight line on a side by side relationship inside the trough receiver.

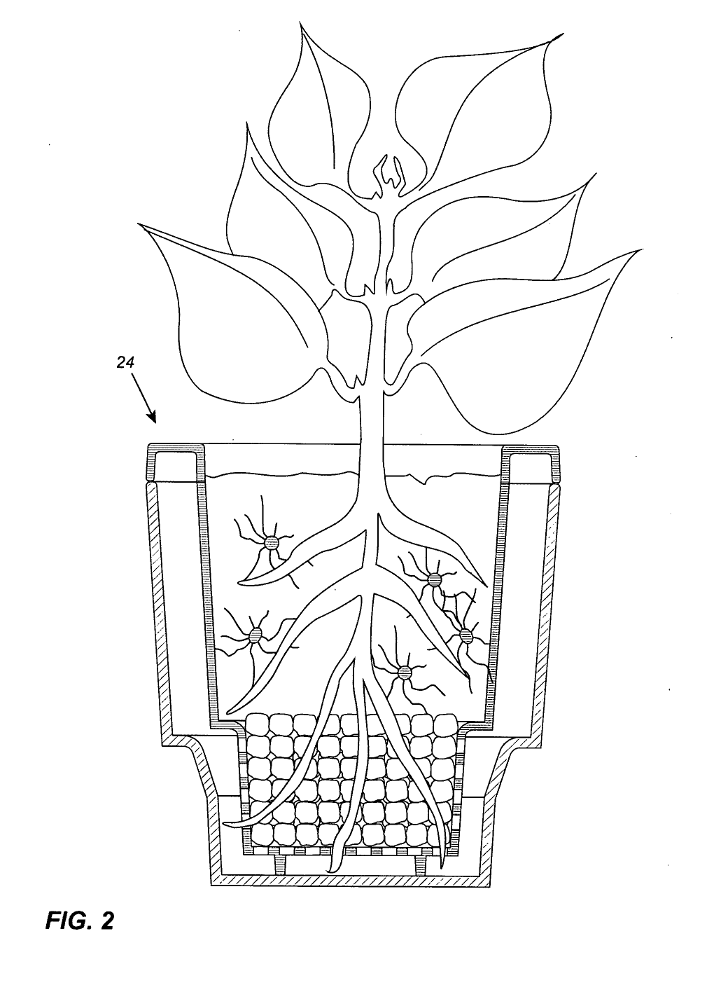

Referring to FIG. 2, an inner insert 26 has an upper inner side wall 28 and an upper outer side wall 30 which defines an air space 32 therebetween. Apertures 34 are provided in the merging section between upper inner side wall 28 and upper outer side wall 30. As may be seen, inner insert 26 seals on both the upper marginal edge of upper side wall 14 and on merging section 18 of outer container 12.

As described in the aforementioned US Patent, there are provided inner cavities defined by inner cavity walls 32 which are formed in a manner similar to that described in the patent and in the embodiment of FIG. 2, i.e. a plurality of apertures created by a screen-like pattern. As shown in FIG. 2, the inner insert 26 has a lower portion thereof filled with an inert coarse growing medium such as thermoexpanded clay beads or sterile cork bark chunks 34 while on top thereof there is supplied a conventional soil 36. In the bottom of container 12 there is provided water which is at a level so as to allow for an air-space.

The soil medium 36 is first inoculated with mycorrhizal fungi. The mycorrhizal fungi spores germinate, and the mycelial filament then infects the root tissues of the plant, and aids the plant being able to access greater element nutrients from the soil (such as phosphorus, copper, iron, etc). These nutrients are basically insoluble, but with the use of the fungi, they become more easily bioavailable. Also, the development of the root system allows the plant to gain access to a larger volume of soil and thereby gain greater access to the nutrition elements and to come in direct contact with beneficial microorganisms.

Those beneficial microorganisms include opportunistic preemptive colonizers such as mycorhization-helper bacteria and mycorrhizae-associated bacteria. They colonize the newly formed mycorrhizal filament coming in contact with the root. These preemptive colonizers in turn recruit other micro-organisms of the PGPR group and start the formation of a biofilm on the surface of the root and fungal filaments through the process of quorum sensing.

Meanwhile PGPF feed the expanding biofilm and encourage further plant growth. They also feed the lactic acid bacteria that condition the soil to pH values that inhibit overproliferation of putrefaction microbes, and leave the way for selected types of organic matter decomposers to decompose organic matter in a controlled manner, instead of at random, such as lignicolous fungi.

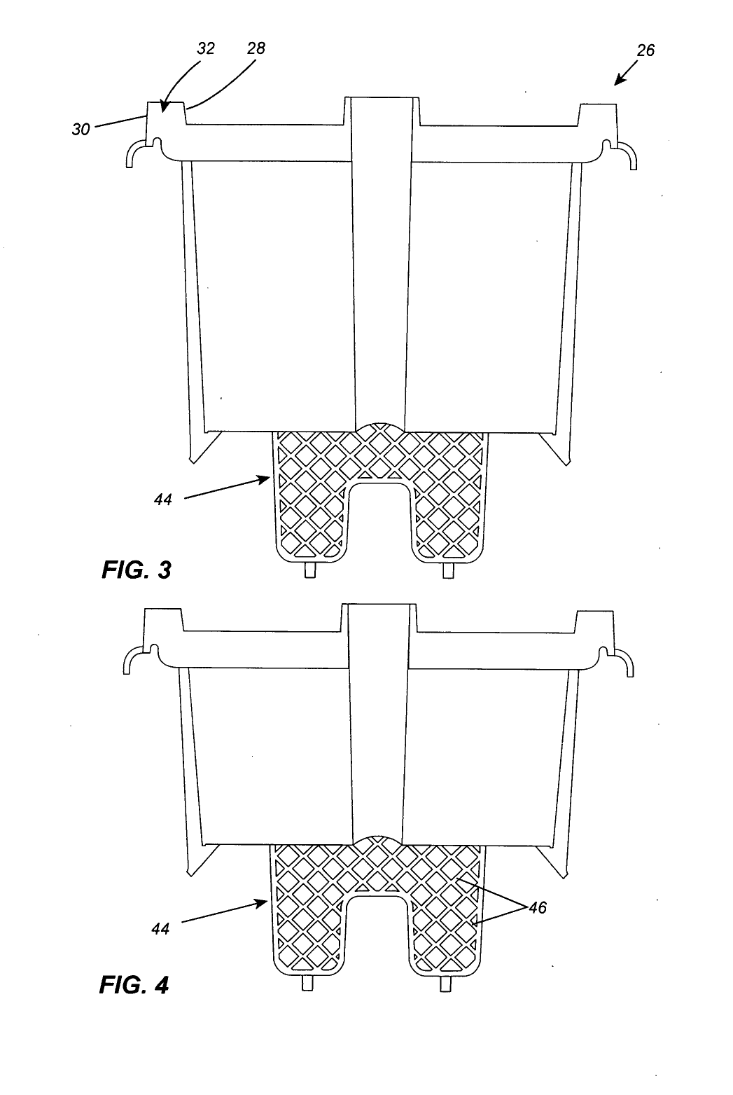

Turning to FIG. 3, an individual cassette insert, or bioreactor element has an upper part and a lower part. The upper part can contain either a thin layer of compost for the purpose of greenhouse agriculture, or a thick layer of compost for the purpose of the cultivation of marsh plants for water filtration.

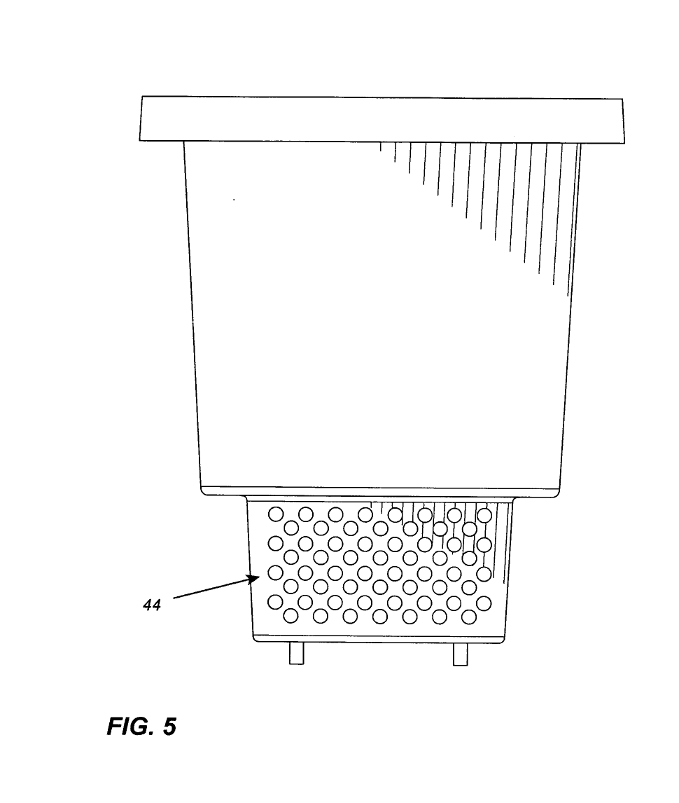

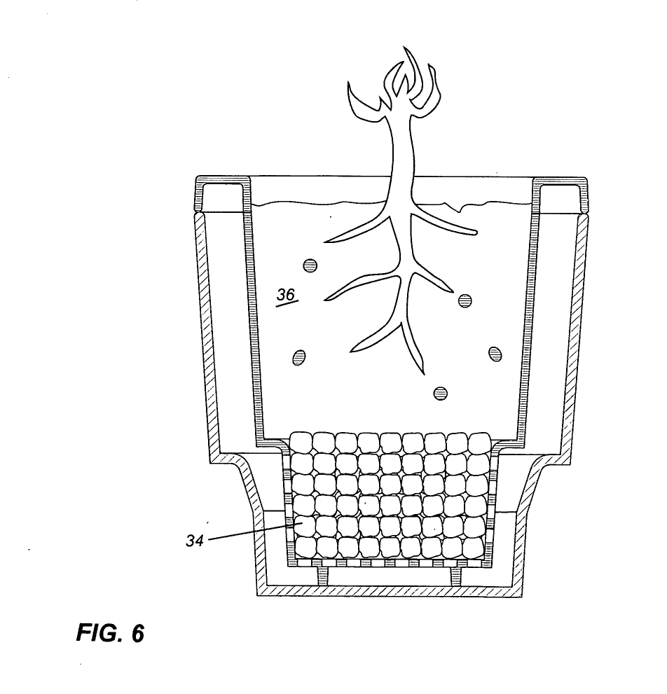

In both cases, the bottom part of said bioreactor has numerous holes 44 created by screen-like threads 46 placed as a criss-cross arrangement. Turning to the arrangement shown in FIGS. 3, 4 and 5, the cassette inserts have a thin upper part as well as a screen-like wall with large apertures that define the cavity containing soilless medium. The apertures should retain the cork bark chunks or the clay beads. The screen-like wall is made of a criss-crossing of material that is especially and intently designed to present a smooth arcuate surface to the roots, as they pass therethrough. Also, as previously mentioned, the screen material is preferably formed in a material which is compliant in nature, ie it can be slightly deformed to easily permit the passage of roots therethrough without damaging the roots.

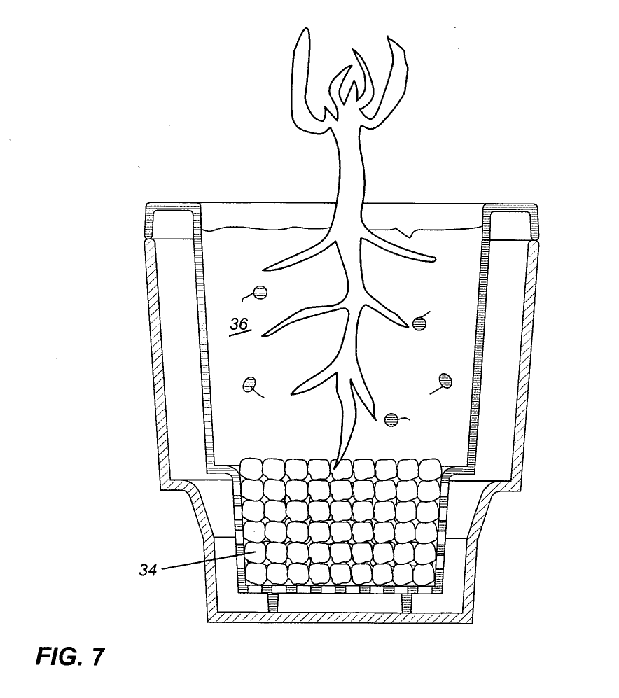

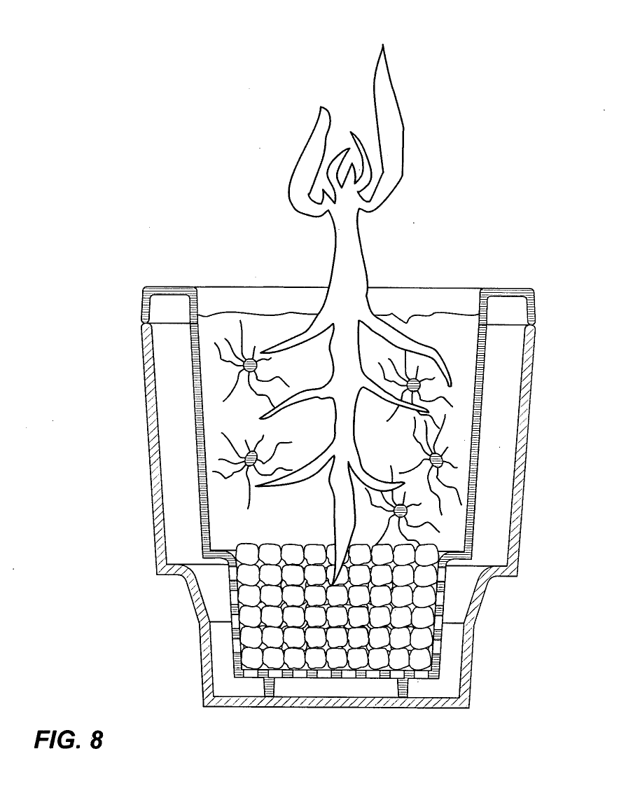

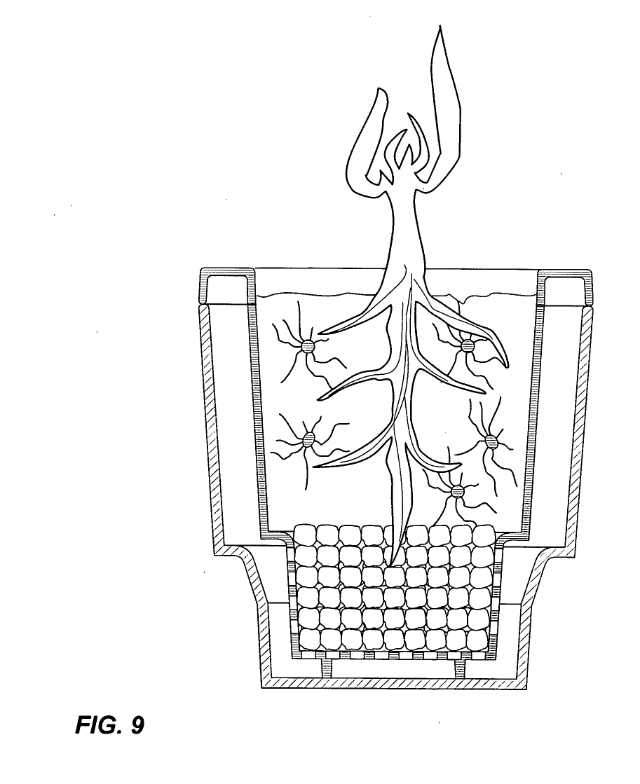

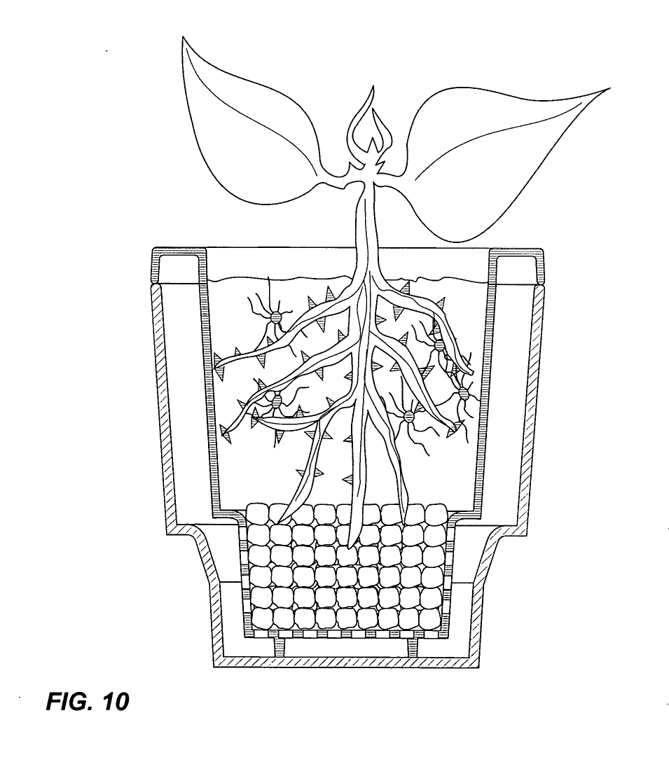

As shown in FIG. 7, following the placement of the mycorhizal inoculation, there is germination within the soil. As seen in FIG. 8, there is further growth in the root and in bacteria. FIGS. 8 and 9 illustrate the infection of the root tissues in the bioreactor. This is followed by mycorhizal colonization of the root with MHA and MHB preemptive colonizer species as shown in FIG. 10.

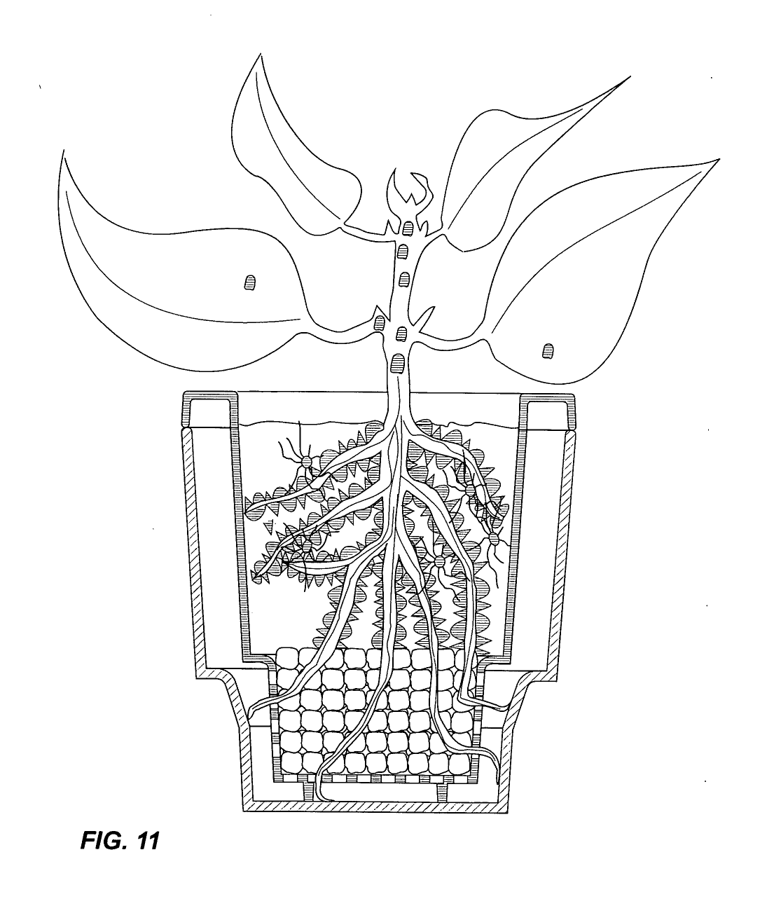

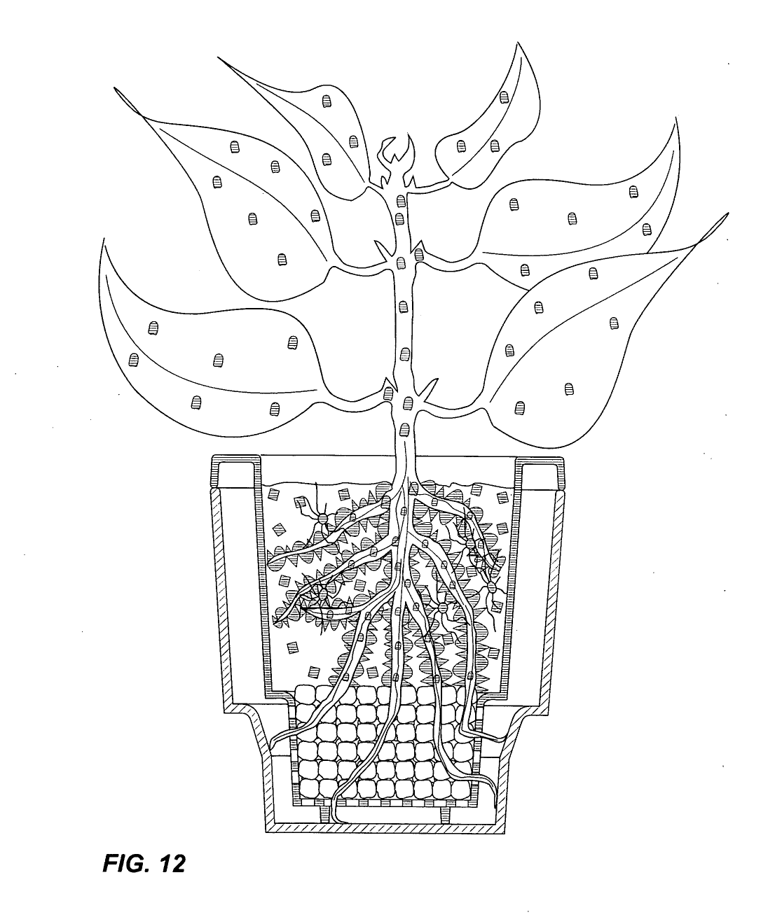

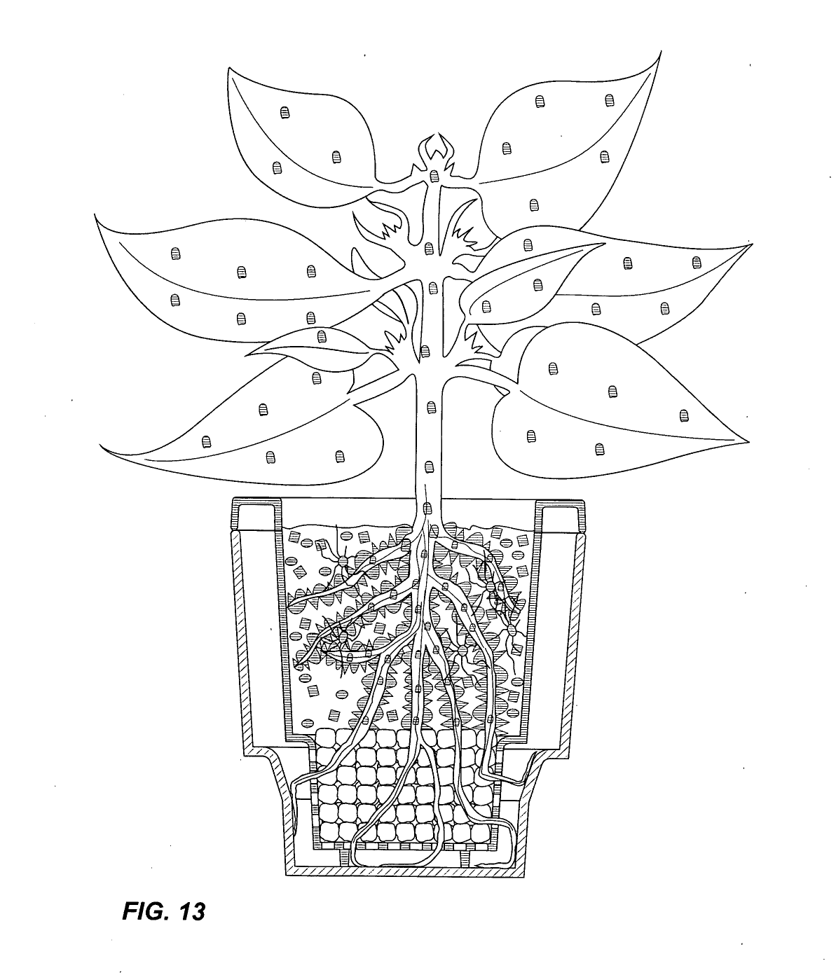

FIG. 11 shows the step of PGPR and bacterial endophyte and fungal endophyte recruitment by MHA and MHB preemptive colonizer species in the bioreactor environment. This is followed by the step of PGPF nourishing action on colonized roots and on SCB lactic acid producing bacterial populations in the bioreactor environment as shown in FIG. 12. Still further, FIG. 13 shows the step of SCB soil conditioning and especially lactic acid producing bacterial populations in the bioreactor environment.

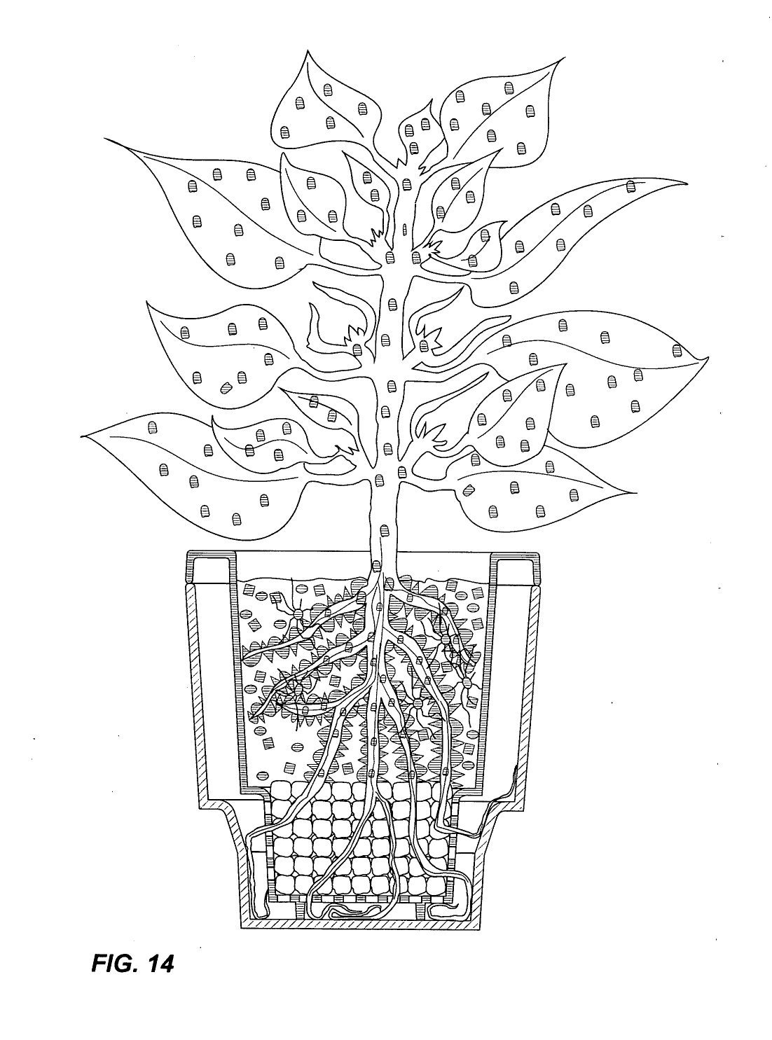

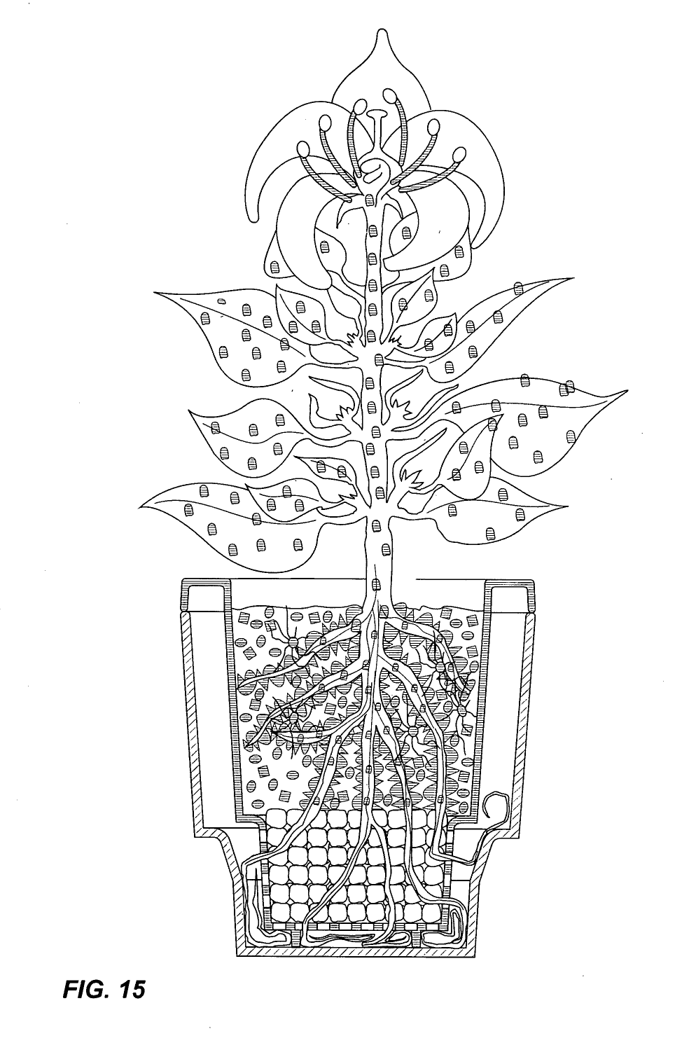

FIG. 14 shows the controlled PDB action in the bioreactor while FIG. 15 shows the step of PSHB probiotic action in the bioreactor.

Gutter receivers can be placed on a side by side relationship in order to cover a large horizontal surface. This arrangement can be used for the purpose of bioremediation, as an urban or periurban modular filtration marsh, for the treatment of water waste (grey water and/or brown water). It can also be used for rooftop urban agriculture purposes.

It is indeed of primordial importance to provide a system in which water is kept running at all times in a bioponic agriculture situation.

Turning to the preferred arrangement, there is provided a plant cultivation system comprising a series of long, gutter-like receivers, a tank for containing water, a pump for allowing movement of water in the bottom of the gutter-like receivers, a dripping system for allowing plants to get watered directly at the base through microirrigation drippers, timers, solenoid valves and proportional fertilizer injectors as part of a complete organic greenhouse infrastructure. Hence, water can be recirculated in a closed loop system configuration through pumping action that should allow water movement as follows: it should be drawn from a large collector tank and pumped up to the other end of the system in a series of distribution pipes in order to reach the lower part of each individual trough, for circulation in the bottom of each trough, before reaching a downwardly extending collector pipe falling in the collection tank, where the cycle can be repeated, thus keeping the water in a constant movement and a constant state of oxygenation. In parallel with the ever recirculating water at the bottom of the system for permanent hydration of the tap root system of plants, an entirely robotized watering system could be provided for providing automatic and reliable fertilizer and bacterial conditioners to each individual plant specimen. This should be done using solenoid valves activated by timers and the flow of water has to be kept unidirectional through the blocking action of check valves and water has to reach the top part of individual cassette inserts through dripping irrigation, directly on the compost phase at the base of the plants, for providing fertilizers and microorganisms to the superficial (nourishing) root system conveniently found in the proximity of said dripping irrigation device.

A series of individual modular gutter-supporting elements can be joined together in a series to be installed in a large enclosure for organic production.

It will be understood that the above described embodiments are for purposes of illustration only and that changes and modifications may be made thereto without departing from the spirit and scope of the invention.

I claim:

1. A method of plant cultivation comprising the steps of:
providing a plant growing system having a container and an insert therefore, said insert having at least one foraminous wall to permit root growth therethrough, said insert being spaced from a bottom of said container;
placing a non soil growing medium into said insert, placing a soil on top of said non soil layered growing medium, supplying water to said container;
supplying a microbial inoculant containing at least one species from each of the following groups of microorganisms:
a) Arbuscular Mycorrhizae;
b) Mycorrhizae Associated Bacteria (MAB);
c) PGPR microorganisms;
d) PGPF yeasts; and
e) SCB.

2. The method of claim 1 further including supplying a bacteria from a PDB group.

3. The method of claim 1 wherein said microbial inoculant is supplied to a plant on a repeat basis.

4. The method of claim 3 wherein said inoculant is supplied at intervals of between 5 and 10 days.

5. The method of claim 4 further including the step of keeping said water flowing at all times.

6. The method of claim 5 further including the step of watering plants in said insert to provide nutrients at a base of the plant.

7. The method of claim 1 further including the step of supplying Mycorrhization Helper Bacteria and Mycorrhizae Associated Bacteria.

8. The method of claim 1 wherein said bacteria in Group 3 further includes at least one species of bacterial endophyte.

9. The method of claim 8 further including the step of including at least one species of fungal endophyte in Group 3.

10. The method of claim 1 further including the step of supplying plant hormone stimulating bacteria.

11. The method of claim 1 wherein said mycorrhizae bacteria are selected from:
a) Glomus irregular;
b) Glomus mossae;
c) Glomus etunicatum; and
d) Glomus fasciculatum spp.

12. The method of claim 1 wherein said MAB are selected from:
a) Bacillus pumilus;
b) Bacillus subtilis;
c) Pseudomonas fluorescens; and
d) Pseudomonas putida.

13. The method of claim 1 wherein said PGPR are selected from:
a) Pseudomonas fluorescens;
b) Pseudomonas aeruginosa;
c) Pseudomonas putida;
d) Paenibacillus polymyxa;
e) Azospirillum brasilense; and
f) Enterobacter agglomerans.

14. The method of claim 1 wherein said PGPF yeasts are selected from:
a) Saccharomyces cerevisiae;
b) Pichia pastoris;
c) Aureobasidium pullulans;
d) Yarrowia lipolytica;
e) Metchnikowia fructicola; and
f) Cryptococcus albidus.

15. The method of claim 1 wherein said SCB are selected from:
a) Lactobacillus casei;
b) Lactobacillus acidophilus;
c) Streptococcus lactis;
d) Streptococcus agalactiae; and
e) Leuconostoc fallax.

16. The method of claim 1 wherein said PDB are selected from:
a) Rhodobacter sphaericus;
b) Rhodobacter capsulatus;
c) Trichoderma harzianum.
